(19) United States
(12) Patent Application Publication
(10) Pub. No.: US 2015/0124959 A1
(43) Pub. Date: May 7, 2015

(54) METHOD, SYSTEM AND DEVICE FOR REDUCING INTERFERENCE BETWEEN A FIRST AND A SECOND DIGITAL SUBSCRIBER LINE

(71) Applicant: Thomas Ahrndt, Ottobrunn (DE)

(72) Inventor: Thomas Ahrndt, Ottobrunn (DE)

(73) Assignee: NOKIA SOLUTIONS AND NETWORKS OY, Espoo (FI)

(21) Appl. No.: 14/389,100

(22) PCT Filed: Mar. 30, 2012
(86) PCT No.: PCT/EP2012/055812

§ 371 Date: Jan. 20, 2015

(51) Int. Cl. H04B 3/32; H04B 3/04

(52) U.S. Cl. CPC H04B 3/32; H04B 3/04
USPC 379/406.12

(57) ABSTRACT

The invention relates to a method and to a device for reducing interference between a first and a second digital subscriber line, DSL. A corresponding communication system is also provided. The invention provides a method wherein interference between a first and a second digital subscriber line is reduced, the method comprising the steps of determining line characteristics of the second DSL and reducing a transmission power of the first DSL based on the line characteristics of the second DSL.

The invention relates to a method and to a device for reducing interference between a first and a second digital subscriber line. A corresponding communication system is also provided.

DSL (Digital Subscriber Line), or xDSL, is a family of technologies that provide digital data transmission over the wires of a local telephone network. It is mostly used for transmission of data to and from the subscriber/customer (or the customer premises equipment—CPE, respectively) to the central office side of the communications network.

As high speed internet access is gaining more and more importance data access for homes (and businesses) is often realized via said xDSL services used on existing copper lines. Furthermore, other applications also emerge that require broadband data transmission services. E.g., so-called triple play services offer subscriber access to Internet, TV and voice data transmission. Especially, the transmission of TV data is a bandwidth consuming application. One HDTV channel, for example, requires a data rate amounting to 12 Mbit/s. These higher transmission rates have to be provided and covered by xDSL technologies.

As requirements for high speed Internet access are increasing, operators are also optimizing services that are offered to their customers. This becomes a difficult task as an increasing amount of users as well as high data rates lead to higher crosstalk in-between subscriber lines, especially in the same cable binder: In most cases multiple subscriber lines share—at least partly—the same cable binder. In a suchlike cable binder multiple lines are installed together. This leads to an increased mutual influence between these subscriber lines, resulting in more crosstalk and interference on the transmission path.

Crosstalk can be divided into two different types: “near end crosstalk” (NEXT) which is interference between two pairs in a cable measured at the same end of the cable as the transmitter and “far end crosstalk” (FEXT) that can be defined as interference between two pairs of a cable measured at the other end of the cable from a transmitter.

Overall crosstalk has to be regarded as one of the most grievous problems in DSL environments causing interference and disturbances in the transmission lines which, in turn, leads to a significant degradation in the system performance.

The problem to be solved is to overcome the disadvantages described above and in particular to provide a functionality that decreases the negative impacts of crosstalk interference.

This problem is solved according to the features of the independent claims. Further embodiments result from the depending claims.

In order to overcome this problem a method for reducing interference between a first and a second digital subscriber line (DSL) is provided, the method comprising the steps of determining line characteristics of the second DSL and reducing a transmission power of the first DSL based on the line characteristics of the second DSL.

By examining the line characteristics of a further transmission line, the DSL transmission on a first line may be advantageously organized such that the influences of the first DSL on the second DSL are minimized.

In a further embodiment the determination of the line characteristics of the second DSL may be performed by means of a line testing method.

As methods for line testing may be implemented for the training of DSL transceivers this line testing functionality could be advantageously used for determining the line characteristics of a further transmission line.

Furthermore, the determination of the line characteristics of the second DSL may be performed by means of a “dual-ended line testing” method (DECT).

In a further embodiment the reduction of the transmission power of the first DSL may be performed in at least one frequency spectrum. Advantageously, a certain frequency spectrum having a particular negative impact may be masked out, for example.

The at least one frequency spectrum may furthermore be determined based on the line characteristics of the second DSL.

Moreover, in an embodiment the line characteristics of the second DSL may comprise a line attenuation. By determining the attenuation of the second line the frequencies used for DSL transmission in the second DSL could be identified.

The frequency spectrum that is defined for reducing the transmission power my furthermore be determined based on the line attenuation of the second DSL.

In a further embodiment the transmission power of the first DSL may be reduced in the context of a power back off method.

Furthermore, the problem stated above is solved by a communication system arranged such that all steps of a method according to any of the method claims can be performed.

The problem stated above is also solved by a device comprising means for reducing interference between a first and a second digital subscriber line, DSL, by reducing a transmission power of the first DSL based on line characteristics of the second DSL.

According to a next embodiment, the device may further comprise means for performing a line testing method for determining the line characteristics of the second DSL.

The device may further comprise means for receiving the line characteristics determined by or in collaboration with a further device.

Furthermore, the device may be a digital subscriber line access multiplexer.

It is further noted that in an embodiment the device may be designed as a processing unit. The processing unit may comprise at least one, in particular several means that are arranged to execute the steps of the methods described herein. The means may be logically or physically separated; in particular several logically separate means could be combined in at least one physical unit.

Moreover, the processing unit may comprise at least one of the following: a processor, a microcontroller, a hard-wired circuit, an ASIC, an FPGA, a logic device.

The solution provided herein further comprises a computer program product directly loadable into a memory of a digital computer, comprising software code portions for performing the steps of the method as described herein.

In addition, the problem stated above may be solved by a computer-readable medium, e.g., storage of any kind, having computer-executable instructions adapted to cause a computer system to perform the methods as described herein.

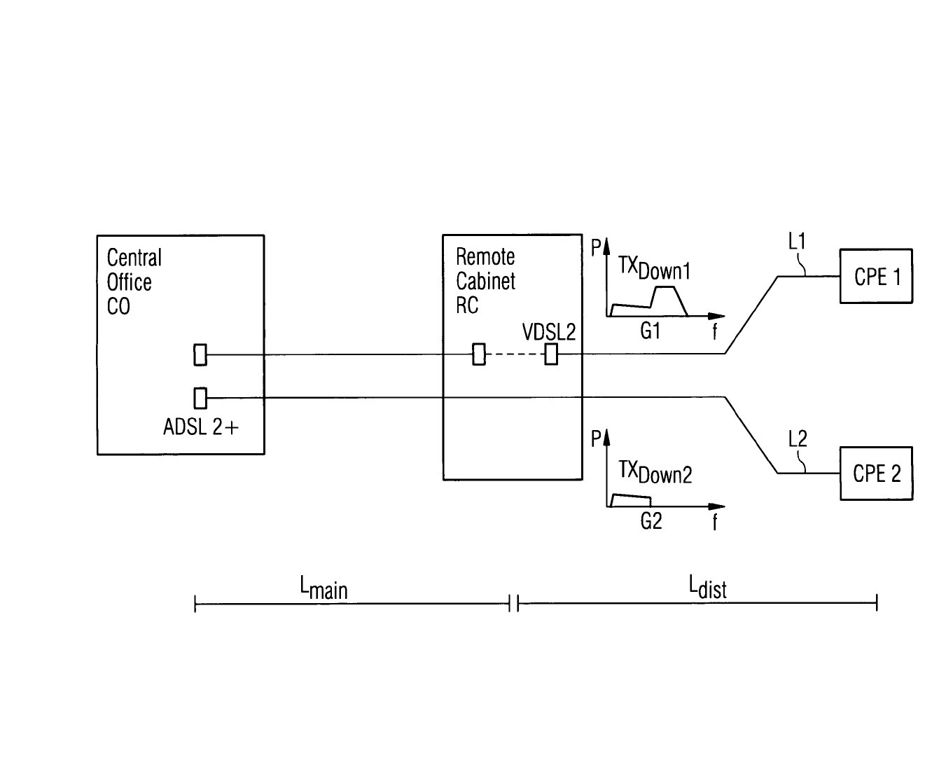

In the following embodiments of the invention are described with the help of FIG. 1. FIG. 1 shows a digital subscriber line environment.

Basically, with increasing bandwidth necessary on the subscriber lines improved DSL technologies evolved. Different standards like ADSL, ADSL2, ADSL2+, VDSL, VDSL2 have different characteristics. ADSL, for example, is capable of a combined downstream (from network side to customer) and upstream (from customer to network) data rate of up to about 9 Mbit/s, whereas VDSL2 is capable of data rates of up to 50 Mbit/s (and more).

The increase in bandwidth range for VDSL, for example, is achieved, amongst other things, by using a greater frequency spectrum (i.e. by using higher frequencies as well). However, using higher frequencies results in a decrease in the possible operating distance due to greater cable attenuation in high frequency spectra. This means that the operating distance for VDSL2, for example, is much less than the operating distance for ADSL or also ADSL2+.

To provide newer DSL technologies to subscribers that are located out of reach of the operating distance for these technologies as well, additional network nodes can be installed on the network side—see FIG. 1, for example.

FIG. 1 shows the access side of a telecommunications network. A central office (CO) can be seen as the connection point of the access network with the core network side (aggregation part of the core network). The central office CO may be configured as a multiplexer combining the subscriber lines of multiple users connected to the network. An example for a suchlike multiplexer is a so-called DSLAM (digital subscriber line access multiplexer).

The CO comprises multiple line cards, each connected to one of the users' customer premises equipment (CPE1, CPE2). Each line card can be designed as a DSL transceiver connected to a transceiver on the customer side (DSL modem). The transmission path may be designed as a digital subscriber line (L1, L2). These lines may be bundled together in a cable binder, at least partly. In FIG. 1 this is indicated by the parallel run of the two lines. Only at a location usually close to the customers' residences the cables will leave the binder and run on independent paths. Naturally, cables in a common binder are usually exposed to greater mutual influences and disturbances. Although FIG. 1 only shows two DSLs a plurality of lines is usually connected to each DSLAM.

In the example depicted in FIG. 1 it is assumed that the operating distance of ADSL2+ is high enough to cover the distances between the central office and the subscriber's locations. CPE2, for example, is connected to the central office via subscriber line L2 and uses ADSL2+ for data transmission. Please note that ADSL2+ is only used as an example; any other possible DSL technology could be used.

It is further assumed in the present embodiment that the operating distance of VDSL2, for example, is, in contrast, not high enough to provide VDSL2 technology to the subscribers if the network side transceiver is located at the central office's position.

However, to be able to provide VDSL2 services to the customers the network operator may install additional network units closer to the subscriber's location. In FIG. 1 these additional units are located at an additional network node depicted as remote cabinet RC. The remote cabinet is located at the path of the legacy subscriber lines, closer to the CPEs. The remote cabinet should, of course, be located close enough to the subscribers for VDSL2 services, i.e. within the reach of the VDSL2 operating distance.

To connect the subscriber lines coming from the customers to the network, the remote cabinet can either convey the data (almost) unaltered or the data can be processed. In FIG. 1 CPE2 is connected via ADLS2+. In this example this means that CPE2 is connected directly to the central office CO. The data are merely conveyed through the remote cabinet using transmission line L2, but no processing is performed. In the case of CPE1, however, a processing of the data is carried out in the remote cabinet: From the remote cabinet RC to CPE1 a VDSL2 connection is established. Furthermore, the data sent in-between the remote cabinet RC and the central office CO (and vice versa) may be transmitted using another, independent transmission method, for example.

With this method CPE1 can be connected to the network using VDSL2 and, therefore, a higher data rate can be provided to CPE1. To achieve this, the connection from the remote cabinet RC to the central office CO must also be capable of transferring the higher amount of data in downstream and upstream direction, of course.

However, when new xDSL technologies are introduced to an access network (like a new VDSL2 connection as in the example depicted in FIG. 1) a change in the overall crosstalk influences occurs. With regard to FIG. 1 this means that the newly added VDSL2 connection in subscriber line L1 leads to a higher interference on line L2. Thus, the legacy subscriber line L2 using ADSL2+ must be protected against this additional VDSL2 crosstalk that is injected by the remote cabinet RC (or the new VDSL2 transceivers, respectively), so that the legacy ADSL2+ connection stays unaffected. Advantageously, the transmit power of the VDSL2 transmitter may be shaped accordingly.

For example, the transmit power spectrum density (PSD) of the VDSL2 transmitter on line L1 may be shaped such that it produces the (almost) same FEXT PSD in the ADSL2+ modem of line L2 as the former FEXT disturber of line L1 which is connected to the central office CO. This can be achieved by a method called downstream power back-off (DPBO). With this method the power spectrum density PSD of the VDSL2 system can be shaped. I.e. the power in certain frequency spectra can be willingly reduced.

Power back-off of the VDSL2 system needs to be applied only in the frequency range where both ADSL2+ and VDSL2 systems overlap (see graphs G1 and G2 in FIG. 1). To implement the downstream power back-off process the border frequency (i.e. the maximum frequency used by the ADSL2+ system) has to be determined. This is normally done according to a configured value of the length of the main cable (Lₘₐᵢₙ), wherein this length corresponds to the distance between the central office CO and the remote cabinet RC.

Generally, the subscriber lines can be divided into two parts: Lₘₐᵢₙ (see above) and L_{dist}. L_{dist} is the distribution part of the lines, meaning the part reaching from the remote cabinet RC to the end units.

If fₘₐₓ is the maximum frequency used by the ADSL2+ link, fₘₐₓ is defined as the frequency where the receive PSD of ADSL230 is equal to a minimally required value PSDₘᵢₙ:

PSD_{ADSL}(f)−aₘₐᵢₙ(f)=PSDₘᵢₙ

In frequencies higher than fₘₐₓ no ADSL2+ transmission occurs—in these frequencies a VDSL2 transmission power on a neighboring line does not have to be reduced as almost no interference will occur from these frequency bands.

The definition for the PSDₘᵢₙ as shown above is usually based on the ADSL2+ level at the output of the main cable, and it neglects the (further) attenuation of the distribution cable L_{dist}. This is done in order to protect the best performing of all possible ADSL2+ (or xDSL, respectively) lines. The above definition can be found in standard document G.997 of the ITU. However, taking into account the attenuation on the distribution cables could also be envisioned.

To calculate the parameters necessary for performing a downstream power back-off, the DSLAMs normally need to know the length of the main cable (Lₘₐᵢₙ). However, the value of Lₘₐᵢₙ is not known to the DSLAMs per se, but has to be manually administered.

For instance, DSLAM operators either check their data bases regarding loop length and main cable characteristics or even have to perform sophisticated cable parameter tests to configure the downstream power back-off parameters. Moreover, especially for competitive local exchange carriers (CLECs) that use the physical lines of their competitors these data bases may not be accessible at all.

According to the present invention the reduction of the transmission power performed, for example, in the context of the power back-off method can be based on line characteristics that are measured automatically. A device may be introduced that performs automated tests in order to calculate all parameters needed for the DPBO. This device (e.g. a standard DSL modem or DSL transceiver) may be, from management point-of-view, connected with the DSLAM in the remote cabinet and configured to calculate the DPBO configuration parameters from measurements (e.g. via DELT) on the main cable.

To implement the downstream power back-off functionality the cable attenuation should be known, for example. According to G.997, the cable attenuation aₘₐᵢₙ(f) can be approximated by three parameters A′, B′, C′:

a(f, Lₘₐᵢₙ)=(A′+B′·\sqrt{f}+C′·f)·Lₘₐᵢₙ

These parameters are usually tailored such that f can be used in MHz and Lₘₐᵢₙ in km. Values for A′, B′ and C′ can be, for example: A′=1; B′=17.2 and C′0.62.

According to G.997 another formula is also proposed:

a(f, EL)=(A+B·\sqrt{f}+C·f)·EL

Here, the parameter EL stands for the loop attenuation of the main cable in dB at 1 MHz, called electrical length. A, B and C are obtained by division of A′, B′ and C′ by

EL@1 km=a_{dist}(1 MHz, 1 km)=A′+B′+C′.

The G.997 coefficients corresponding to those above can be set to, for example: A=0.0531; B=0.9139 and C=0.0329.

If the second model is applied for DPBO purposes, an EL defined at 1 MHz must be configured, representing the electrical length from the exchange to the cabinet.

According to the invention the dual-ended line testing functionality can be used for determining the line characteristics and the line attenuation. DELT is defined, for example, by the ITU-T standards G.992.3 (ADSL2) and G.992.5 (ADSL2+) or G.993.2 (VDSL2) as line diagnostics mode.

By means of DELT channel information can be determined such as line attenuation, signal attenuation, signal-to-noise ratio margin, attainable net data rate and actual aggregate transmit power. With the help of this information subcarrier information representing the characteristics of different subcarriers used in DSL technology can be determined. This information can comprise channel characteristics, quiet line noise and signal-to-noise ratio (SNR).

Again, with this subcarrier information different further analysis can be made. Using the channel characteristics the condition of the physical copper line can be analyzed, for example. Furthermore by means of the quiet line noise the crosstalk can be analyzed and by means of the SNR time-dependent changes in the crosstalk levels and the line attenuation can be monitored. These changes may be caused by moisture and temperature variation, for example.

Generally speaking, DELT is often used to determine why the data rate on a transmission line is not equal to the maximum data rate given for a certain line. Normally, the DELT functionality is performed by the DSLAM on the network side to identify problems on all DSLs connected.

In the present example a CPE (which is connected with the DSLAM in the CO) is used to perform measurement of the main cable. Also, it is possible to install a DSL unit (or a standard DSL modem) capable of line testing in the remote cabinet RC.

By performing at least three measurements (at different frequencies, preferably) the parameters A, B, and C needed for calculating the line attenuation (see above) can be determined.

By performing a DELT, the line attenuation and the line characteristics for all subcarriers (having different carrier frequencies) can be determined. Using three measurement values for, e.g. f=100 kHz, 200 kHz and 300 kHz, the values A, B and C can be calculated from the equation described above:

a(f)=(A+B·\sqrt{f}+C·f)

For the three parameters the following formulas can be defined:

$$A = \frac{\begin{matrix}a ( 0.2 ) \cdot ( \sqrt{0.3} - 3 \cdot \sqrt{0.1} ) - 2 \cdot ( \sqrt{0.3} - 3 \cdot \sqrt{0.1} ) \cdot a ( 0.1 ) - \\ ( \sqrt{0.2} - 2 \cdot \sqrt{0.1} ) \cdot ( a ( 0.3 ) - 3 \cdot a ( 0.1 ) )\end{matrix}}{( 2 \cdot \sqrt{0.2} - 2 \cdot \sqrt{0.1} )}$$

$$B = \frac{a ( 0.2 ) - 2 \cdot a ( 0.1 ) + A}{\sqrt{0.2} - 2 \cdot \sqrt{0.1}}$$

$$C = 10 \cdot ( a ( 0.1 ) - A - B \sqrt{0.1} )$$

Thus, according to the invention the DPBO parameters can advantageously be determined without, for example, any expert know-how from the DSLAM operator. As explained above, this is especially important for CLECs that may have no access to access to the databases comprising the line information.

Instead of just using measurement results at three frequencies it is of course also possible to use more measurements to avoid a wrong DPBO calculation. This could be the case, for example, if one specific measurement at a single frequency was not performed with appropriate accuracy.

According to embodiments of the invention, any suitable entity (e.g. components, units and devices) disclosed herein can at least in part be provided in the form of respective computer programs which enable a processor device to provide the functionality of the respective entities as disclosed herein. According to other embodiments, any suitable entity disclosed herein may be provided in hardware. According to other—hybrid—embodiments, some entities may be provided in software while other entities are provided in hardware.

It should be noted that any entity disclosed herein (e.g. components, units and devices) are not limited to a dedicated entity as described in some embodiments. Rather, the herein disclosed subject matter may be implemented in various ways and with various granularities on device level while still providing the desired functionality. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein.

It should be noted that the term “comprising” does not exclude other elements or steps. It may also be possible in further refinements of the invention to combine features from different embodiments described herein above. It should also be noted that reference signs in the claims should not be construed as limiting the scope of the claims.

1. A method for reducing interference between a first digital subscriber line and a second digital subscriber line, comprising the steps of:
determining line characteristics of the second digital subscriber line,
reducing a transmission power of the first digital subscriber line based on the line characteristics of the second digital subscriber line.

2. The method according to claim 1, wherein the determination of the line characteristics of the second digital subscriber line is performed by means of a line testing method.

3. The method according to claim 1, wherein the determination of the line characteristics of the second digital subscriber line is performed by means of a dual-ended line testing method.

4. The method according to claim 1, wherein the reduction of the transmission power of the first digital subscriber line is performed in at least one frequency spectrum.

5. The method according to claim 4, wherein the at least one frequency spectrum is determined based on the line characteristics of the second digital subscriber line.

6. The method according to claim 1, wherein the line characteristics of the second digital subscriber line comprise a line attenuation.

7. The method according to claim 6, wherein the frequency spectrum is determined based on the line attenuation of the second digital subscriber line.

8. The method according to claim 2, wherein the transmission power of the first digital subscriber line is reduced in the context of a power back-off method.

9. A communication system comprising means arranged such that all steps of a method according to claim 1 can be performed.

10. A device comprising means for reducing interference between a first digital subscriber line and a second digital subscriber line by reducing a transmission power of the first digital subscriber line based on line characteristics of the second digital subscriber line.

11. The device according to claim 10, further comprising means for performing a line testing method for determining the line characteristics of the second digital subscriber line.

12. The device according to claim 10, further comprising means for receiving the line characteristics determined by or in collaboration with a further device.

13. The device according to claim 10, wherein the device is a digital subscriber line access multiplexer.
